(19) United States
(12) Patent Application Publication
(10) Pub. No.: US 2020/0053024 A1
(43) Pub. Date: Feb. 13, 2020

(54) METHOD OF TRANSFERRING MIRROR PACKET AND SYSTEM FOR TRANSFERRING MIRROR PACKET

(71) Applicant: FUJITSU LIMITED, Kawasaki-shi (JP)

(72) Inventors: KAZUHIRO SUZUKI, Kawasaki (JP); YUKIHIRO WATANABE, Kawasaki (JP)

(73) Assignee: FUJITSU LIMITED, Kawasaki-shi (JP)

(21) Appl. No.: 16/530,220

(22) Filed: Aug. 2, 2019

(30) Foreign Application Priority Data
Aug. 9, 2018 (JP) 2018-150323

(51) Int. Cl. H04L 12/931; H04L 12/46; G06F 9/455

(52) U.S. Cl. CPC H04L 49/208; H04L 49/70; G06F 2009/45591; G06F 9/45558; G06F 2009/45595; H04L 12/4679

(57) ABSTRACT

A computer-implemented method of transferring a mirror packet includes obtaining a first mirror packet, transferring, based on a first virtual local area network identifier added to the first mirror packet when only a first port permits passage of a mirror packet to which the first virtual local area network identifier is added, the first mirror packet to the first port, and transferring, based on the first virtual local area network identifier added to the first mirror packet when a plurality of ports permit passage of a mirror packet to which the first virtual local area network identifier is added, the first mirror packet to a second port for which only a single destination address is registered, the second port being included in the plurality of ports.

### CROSS-REFERENCE TO RELATED APPLICATION

This application is based upon and claims the benefit of priority of the prior Japanese Patent Application No. 2018-150323, filed on Aug. 9, 2018, the entire contents of which are incorporated herein by reference.

### FIELD

The embodiment discussed herein is related to a mirror packet transfer techniques.

### BACKGROUND

For example, business entities providing services to users (also simply referred to as “business entities” hereinafter) construct and operate information processing systems for providing services to the users. Examples of the information processing systems constructed by the business entities include, for example, an information processing system that uses virtual machines (also referred to as “VMs” hereinafter) and virtual switches generated in physical machines.

In the information processing system as described above, for example, the virtual switches generate mirror packets from packets input/output at ports connected to VMs and transfers the generated mirror packets to another

VM (also referred to as “monitoring VM” hereinafter). For example, the monitoring VM analyzes each of the mirror packets transferred from the virtual switches. Thus, the monitoring VM is able to monitor the packets traveling through the virtual switches.

For example, the elated-art techniques are disclosed in Japanese Laid-open Patent Publication Nos. 2009-088936 and 2009-033719.

### SUMMARY

According to an aspect of the embodiments, a computer-implemented method of transferring a mirror packet includes obtaining a first mirror packet, transferring, based on a first virtual local area network identifier added to the first mirror packet when only a first port permits passage of a mirror packet to which the first virtual local area network identifier is added, the first mirror packet to the first port, and transferring, based on the first virtual local area network identifier added to the first mirror packet when a plurality of ports permit passage of a mirror packet to which the first virtual local area network identifier is added, the first mirror packet to a second port for which only a single destination address is registered, the second port being included in the plurality of ports.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system;

FIG. 2 is a diagram illustrating a configuration of the information processing system;

FIG. 3 is a diagram illustrating a configuration,of the information processing system;

FIG. 4 is a diagram illustrating a configuration of the information processing system;

FIG. 5 is a diagram illustrating a hardware configuration of a physical machine;

FIG. 6 is a diagram illustrating a hardware configuration of another physical machine;

FIG. 7 is a functional block diagram of a virtual switch (SW);

FIG. 8 is a functional block diagram of another SW;

FIG. 9 is a flowchart illustrating an overview of mirror packet transfer processing according to a first embodiment;

FIG. 10 is a diagram illustrating an overview of the mirror packet transfer processing according to the first embodiment;

FIG. 11 is a diagram illustrating an overview of the mirror packet transfer processing according to the first embodiment;

FIG. 12 is a flowchart illustrating the details of the mirror packet transfer processing according to the first embodiment;

FIG. 13 is a flowchart illustrating the details of the mirror packet transfer processing according to the first embodiment;

FIG. 14 is a flowchart illustrating the details of the mirror packet transfer processing according to the first embodiment;

FIG. 15 is a flowchart illustrating the details of the mirror packet transfer processing according to the, first embodiment;

FIG. 16 is a flowchart illustrating the details of the mirror packet transfer processing according to the first embodiment;

FIG. 17 is a diagram illustrating an example of information generation processing;

FIG. 18 is a diagram illustrating an example of information generation processing;

FIG. 19 is a diagram illustrating an example of address information;

FIG. 20 is a diagram illustrating art example of transfer information; and

FIG. 21 is a diagram illustrating are example of a mirror packet to which a virtual local area network identifier (VLANID) is added.

### DESCRIPTION OF EMBODIMENTS

Here, for example, when a network between physical machines in which virtual machines (VMs) are generated are connected through a tunnel, a virtual switch is generated in each of the physical machines. This virtual switch performs tunneling processing on packets transmitted to the other physical machine.

For example, in this case, in the virtual switch performing the tunneling processing, information indicative of the physical machine in which the monitoring VM is generated is generated in addition to the tunneling processing performed on the packets. The virtual switch performing the tunneling processing refers to the generated information so as to transmit to the monitoring VM the mirror packets on which the tunneling processing is performed.

In contrast, for example, when a network between the physical machines irk which the VMs are operated are connected through a virtual local area network (VLAN) such as a network for which the data plane development kit (DPDK) is used, it is not required to perform the tunneling processing in the physical machines. Thus, the virtual switches performing the tunneling processing are not generated in the physical machines. Consequently, in this case, each of the physical machines is not able to identify a physical machine in which, the monitoring VM is generated, and accordingly, the physical machine is not able to transmit the mirror packets to the monitoring VM.

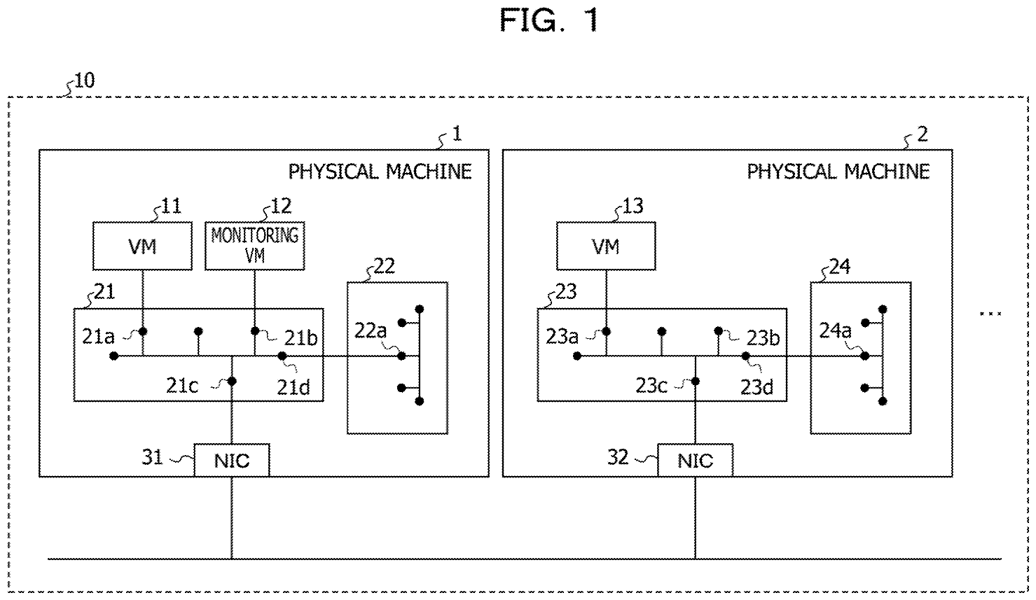

A configuration of an information processing system 10 is described. FIGS. 1 to 4 are diagrams illustrating configurations of the information processing system 10. For example, the information processing system 10 includes a plurality of physical machines including a physical machine 1 and a physical machine 2.

Each of the physical machine 1 and the physical machine 2 includes, for example, hardware (not illustrated) that includes a central processing unit (CPU), a dynamic random-access memory (DRAM), a hard disk drive (HDD), a network, and so forth. Virtualization software (not illustrated) is operated on the hardware of each of the physical machine 1 and the physical machine 2.

The virtualization software of the physical machine 1 allocates parts of the hardware of the physical machine 1 to generate, for example, a VM 11, a monitoring VM 12, a virtual switch 21 (also referred to as “SW 21” or “first SW 21” hereinafter), and a virtual switch 22 (also referred to as “SW 22” hereinafter) as illustrated in FIG. 1.

The virtualization software of the physical machine 2 allocates parts of the hardware of the physical machine 2 to generate, for example, a VM 13 a virtual switch 23 (also referred to as “SW 23” or “second SW 23” hereinafter), and a virtual switch 24 (also referred to as “SW 24” hereinafter) as illustrated in FIG. 1.

For example, the SW 21 includes a plurality of ports including a port 21a, a port 21b, a port 21c, and a port 21d and replicates packets transmitted from the VM 11 to generate mirror packets. For example, the SW 21 transmits the generated mirror packets to the SW 22 in accordance with settings of Open low, which is a protocol for controlling transfer of the packets. Likewise, for example, when the SW 21 receives packets (mirror packets) from one of the physical machines other than the physical machine 1 (for example, the physical machine 2), the SW 21 transmits the received packets to the SW 22. After that, for example, the SW 21 transmits the packets transferred from the SW 22 to the monitoring VM 12. In the example illustrated in FIG. 1, the port 21a, the port 21b, the port 21c, and the port 21d are respectively connected to the VM 11, the monitoring VM 12, a network interface card (NIC) 31 of the physical machine 1, and the SW 22.

For example, the SW 22 includes a plurality of ports including a port 22a and transmits mirror packets transmitted from the SW 21 to a virtual switch connected to the monitoring VM 12 in accordance with the settings of the OpenFlow. For example, the SW 22 transmits the mirror packets transmitted from the SW 21 to the SW 21. In the example illustrated in FIG. 1, the port 22a is connected to the SW 21.

For example, the SW 23 includes a plurality of ports including a port 23a, a port 23b, a port 23c, and a port 23d and replicates packets transmitted from the VM 13 to generate mirror packets. For example, the SW 23 transmits the generated mirror packets to the SW 24 in accordance with the settings of the OpenFlow. Likewise, for example, when the SW 23 receives packets (mirror packets) from one of the physical machines other than the physical machine 2 (for example, the physical machine 1), the SW 23 transmits the received packets to the SW 24. After that, for example, the SW 23 transmits the packets transferred from the SW 24 to the monitoring VM 12. In the example illustrated in FIG. 1, the port 23a, the port 23c, and the port 23d are respectively connected to the VM 13, the SW 24 and an NIC 32 of the physical machine 2.

For example, the SW 24 includes a plurality of ports including a port 24a and transmits mirror packets transmitted from the SW 23 to a virtual switch connected to the monitoring VM 12. For example, the SW 24 transmits the mirror packets transmitted from the SW 23 to the SW 23. In the example illustrated in FIG. 1, the, port 24a is connected to the SW 21

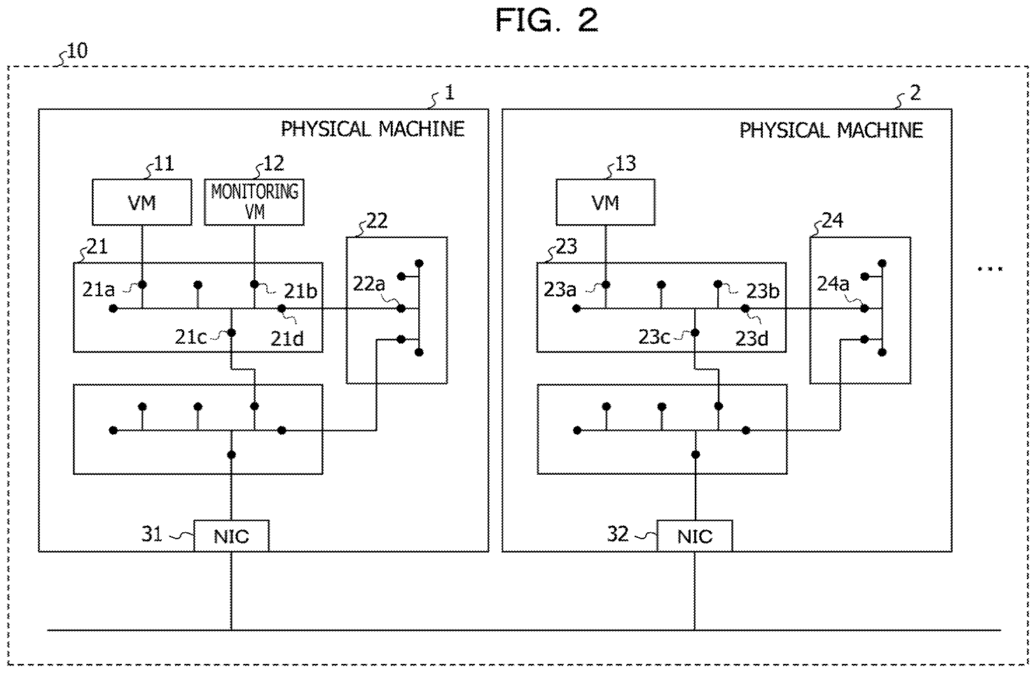

Here, for example, when a network between the physical machine 1 and the physical machine 2 is connected through a tunnel, a virtual switch is generated in each of the physical machine 1 and the physical machine 2. This virtual switch performs tunneling processing on mirror packets transmitted to the other physical machine. For example, as illustrated in FIG. 2, a virtual switch 41 (also referred to as “SW 41 hereinafter”) and a virtual switch 42 (also referred to as “SW 42” hereinafter) are respectively generated in the physical machine 1 and the physical machine 2 as virtual switches performing the tunneling process.

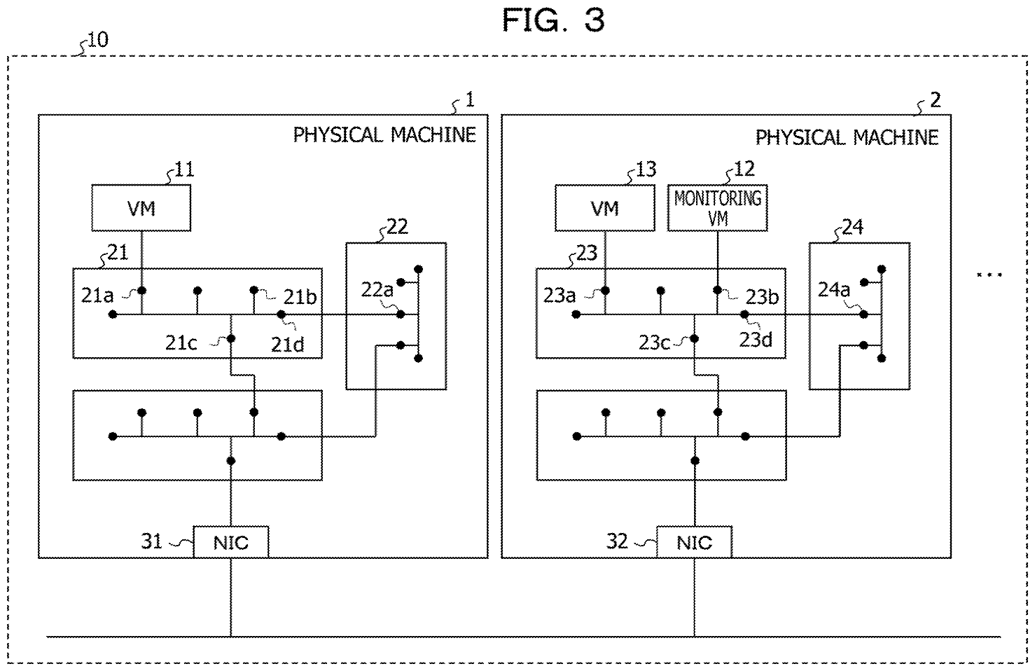

In this case, in addition to the tunneling processing performed on the packets transmitted to the other physical machine, information indicative of the physical machine where the monitoring VM 12 is generated is generated in the SW 41 and SW 42. For example, as illustrated in FIG. 2, when the monitoring VM 12 is generated in the physical machine 1, the SW 42 generates information indicative of generation, of the monitoring VM 12 in the physical machine 1 for transmitting to the monitoring VM 12 mirror packets of packets transmitted from the VM 13. For example, as illustrated in FIG. 3, when the monitoring VM 12 is generated in the physical machine 2, the SW 41 generates information indicative of generation of the monitoring VM 12 in the physical machine 2 for transmitting to the monitoring VM 12 mirror packets of packets transmitted from the VM 11.

Thus, the monitoring VM 12 is able to collect mirror packets transmitted from a VM generated in a different physical machine from a physical machine where the monitoring VM 12 is generated.

In contrast, as illustrated in FIG. 1, when the network between the physical machine 1 and physical machine 2 is connected through a virtual local area network (VLAN), neither the SW 41 nor the SW 42 is generated in the physical machine 1 or physical machine 2 because the tunneling processing is not required. Thus, in this case, the SW 22 transmits packets transmitted from the SW 21 as it is to the SW 21. Also in this case, the SW 24 transmits packets transmitted from the SW 23 as it is to the SW 23.

However, unlike the SW 41 or the SW 42, the SW 21 or the SW 23 is not able to identify the physical machine where the monitoring VM 12 is generated. Thus, in some cases, the SW 21 or the SW 23 is not able to transmit to the monitoring VM 12 mirror packets transmitted from the SW 22 or the SW 24.

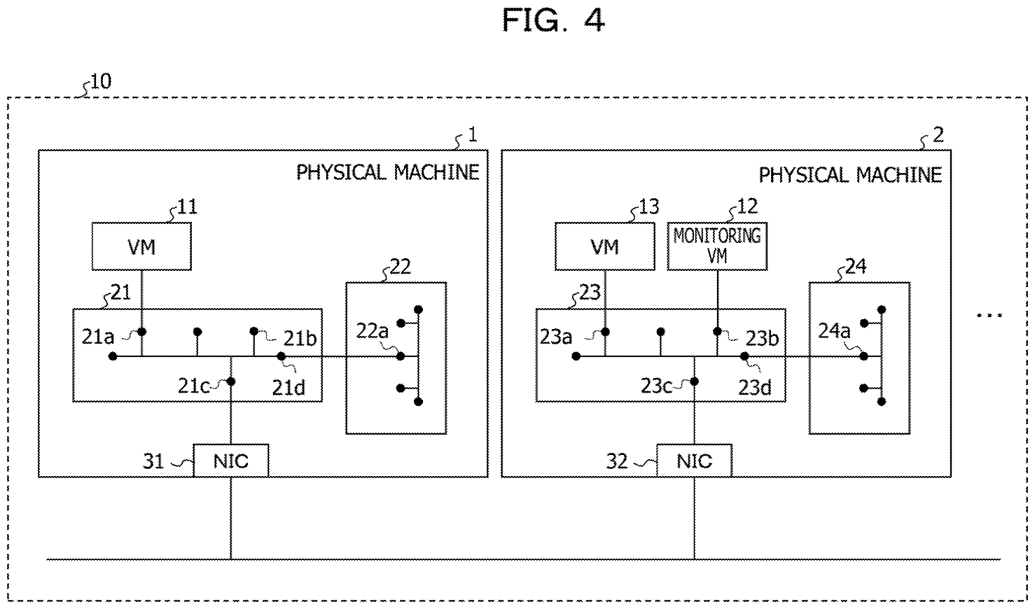

For example, in the case where the SW 41 is not generated in the physical machine 1, the SW 21 is not able to determine, when the SW 21 receives mirror packets from the SW 22, whether the, monitoring VM 12 is generated in the physical machine 1 as illustrated in FIG. 1 or the physical machine 2 as illustrated in FIG. 4. Likewise, in the case where the SW 42 is not generated in the physical machine 2, the SW 23 is not able to determine, when the SW 23 receives mirror packets from the SW 24, whether the monitoring VM 12 is generated in the physical machine 1 as illustrated in FIG. 1 or the physical machine 2 as illustrated in FIG. 4. Thus, in some cases, the SW 21 or the SW 23 is not able to transmit mirror packets to the monitoring VM 12.

For addressing this, for example, according to the present embodiment, for VLAN identifiers (VLANIDs) added to mirror packets, the SW 21 identifies, on a VLANID-by-VLANID basis, ports that permit passage of the mirror packets to which VLANIDs are added. Then, the SW 21 generates transfer information indicating that a mirror packet to which a VLANID by which a single port is identified is added is to be transferred to the identified port and that a mirror packet to which a VLANID by which two ports are identified is added is to be transferred to one port to which a single virtual machine (VM) is connected out of the identified ports.

Then, when a new mirror packet (also referred to as “first mirror packet” hereinafter) is generated due to reception of a packet from the VM 11, the SW 21 refers to a storage unit storing the transfer information and transmits the first mirror packet to a port corresponding to the first mirror packet (also referred to as “first port” hereinafter).

For example, the SW 21 identifies the number of ports corresponding to VLANs on a VLAN-by-VLAN basis, and further, identifies the number of VMs connected to each of the ports ahead of the port. When a VLAN corresponding to a single port exists, the SW 21 determines that the monitoring VM 12 for this VLAN is generated in the physical machine 2 different from the physical machine where the SW 21 is generated. When a VLAN corresponding to two ports exists, the SW 21 determines, in accordance with the number of VMs connected to each of the ports ahead of the port, the physical machine in which the monitoring VM 12 for this VLAN is generated.

Thus, even when a virtual switch performing the tunneling processing (the virtual switch that generates information for identifying a physical machine where the monitoring VM 12 is generated) does not exist in the same physical machine, the SW 21 is able to transfer the mirror packet to the monitoring VM 12.

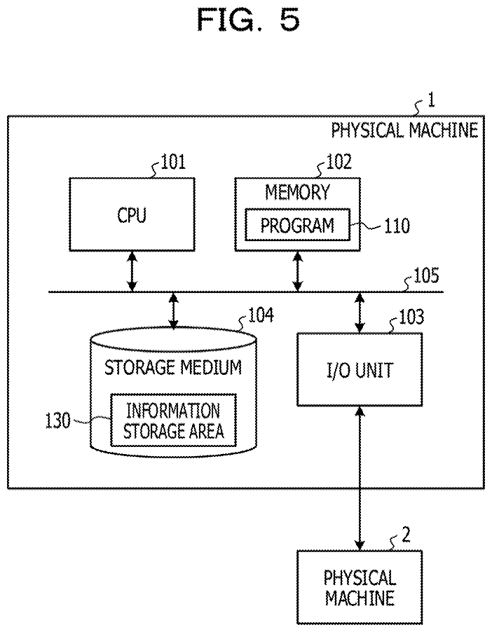

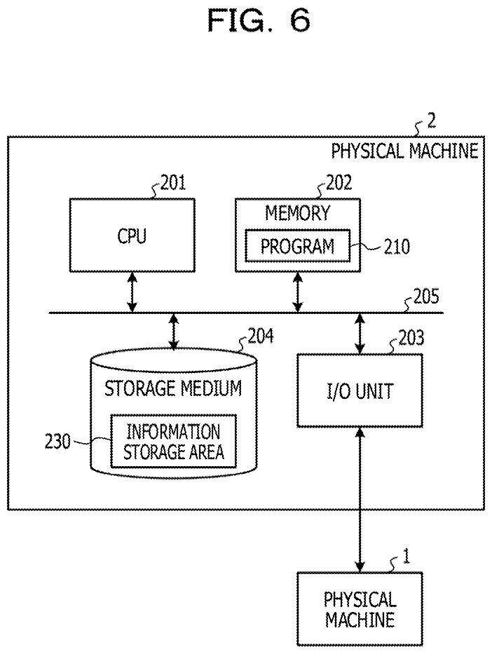

Next, a hardware configuration of the information processing system 10 will be described. FIG. 5 is a diagram illustrating a hardware configuration of the physical machine 1. FIG. 6 is a diagram illustrating a hardware configuration of the physical machine 2.

As illustrated in FIG. 5, the physical machine 1 includes a CPU 101 as a processor, a memory 102, an external interface (input/output (I/O) unit) 103, and a storage medium 104. These components are connected to one another via a bus 105.

The storage medium 104 includes a program storage area (not illustrated) that stores, for example, a program 110 for performing processing for transferring mirror packets to the monitoring VM 12 (also referred to as “mirror packet transfer processing” hereinafter). The storage medium 104 also includes a storage unit 130 (also referred to as “information storage area 130” hereinafter) that stores, for example, information used when the mirror packet transfer processing is performed. The storage medium 104 may be, for example, an HDD.

The CPU 101 executes the program 110 loaded from the storage medium 104 into the memory 102 to perform the mirror packet transfer processing.

The external interface 103 performs, for example, communication with the physical machine 2.

As illustrated in FIG. 6, the physical machine 2 includes a CPU 201 as a processor, a memory 202, an external interface (I/O unit) 203, and a storage medium 204. These components are connected to one another via a bus 205.

The storage medium 204 includes a program storage area (not illustrated) that stores, for example, a program 210 for performing mirror packet transfer processing. The storage medium 204 also includes a storage unit 230 (also referred to as “information storage area 230” hereinafter) that stores, for example, information used when the mirror packet transfer processing is performed. The storage medium 204 may be, for example, an HDD.

The CPU 201 executes the program 210 loaded from the storage medium 204 into the memory 202 to perform the mirror packet transfer processing.

The external interface 203 performs, for example, communication with the physical machine 1.

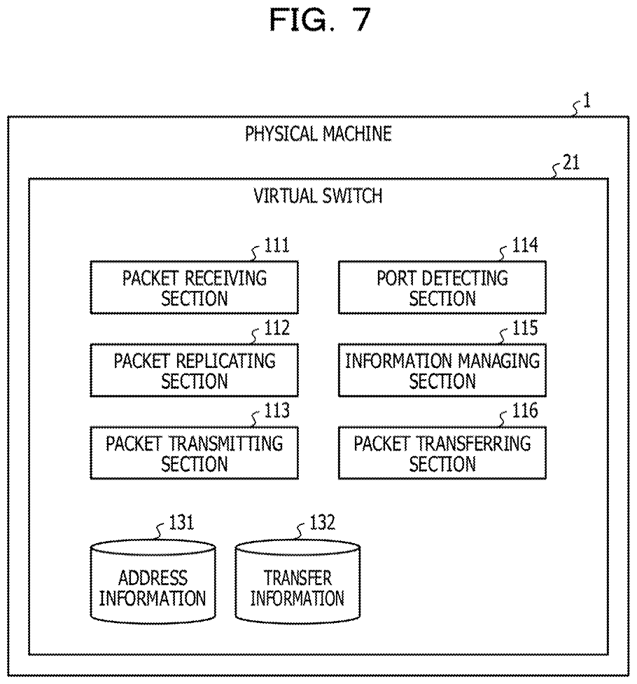

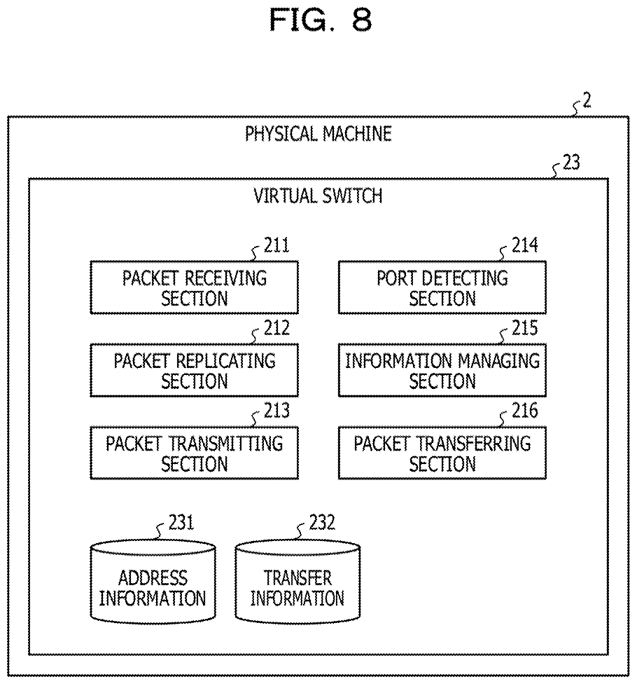

Next, functions of the information processing system 10 is described. FIG. 7 is a functional block diagram of the SW 21. FIG. 8 is a functional block diagram of the SW 23.

As illustrated in FIG. 7, the SW 21 realizes a variety of functions including a packet receiving section 111, a packet replicating section 112, a packet transmitting section 113, a port detecting section 114, an information managing section 115, and a packet transferring section 116 in such a way that the hardware such as the CPU 101 and the memory 102 of the physical machine 1 and the program 110 organically cooperate with each other.

As illustrated in FIG. 7, the SW 21 stores address information 131 and transfer information 132 in the information storage area 130.

The packet receiving section 111 receives packets transmitted from outside the SW 21. For example, the packet receiving section 111 receives packets transmitted from the VM 11 and packets transmitted from SW 22. The packet receiving section 111 also receives packets transmitted from, for example, the physical machine 2 (VM 13) through the NIC 31.

For example, the packet replicating section 112 replicates the packets transmitted from the VM 11 to generate mirror packets.

The packet transmitting section 113 transmits packets to the outside of the SW 21. For example, the packet transmitting section 113 transmits packets to the SW 22. The packet transmitting section 113 also transmits packets to, for example, the physical machine 2 (VM 13) through the NIC 31.

For VLANIDs added to mirror packets, the port detecting section 114 identifies, on a VLANID-by-VLANID basis, ports that permit passage of the mirror packets to which VLANIDs are added. Then, the port detecting section 114 generates the transfer information 132 indicating that a mirror packet to which a VLANID by which a single port is identified is added is to be transferred to the identified port and that a mirror packet to which a VLANID by which two ports are identified is added is to be transferred to one port to which a single VM is connected out of the identified ports.

For example, the port detecting section 114 refers to the address information 131 indicative of media access control (MAC) addresses of the VMs connected to the ports to identify the number of the connected VMs for each of the identified ports.

The information managing section 115 stores the transfer information 132 generated by the port detecting section 114 to the information storage area 130.

When a packet received from the VM 11 is replicated to generate the first mirror packet, the packet transferring section 116 refers to the information storage area 130 storing the transfer information 132 to identify the first port corresponding to the first mirror packet. Then, the packet transferring section 116 transfers the first mirror packet to the identified first port.

As illustrated in FIG. 8, the SW 23 realizes a variety of functions including a packet receiving section 211, a packet replicating section 212, a packet transmitting section 213, a port detecting section 214, an information managing section 215, and a packet transferring section 216 in such a way that the hardware such as the CPU 201 and the memory 202 of the physical machine 2 and the program 210 organically cooperate with each other.

As illustrated in FIG. 8, the SW 23 stores address information 231 and transfer information 232 in the information storage area 230.

Description of the functions of the packet receiving section 211, the packet replicating section 212, the packet transmitting section 213, the port detecting section 214, the information managing section 215, and the packet transferring section 216 is omitted because the functions of these sections are the same as the functions of the packet receiving section 111, the packet replicating section 112, the packet transmitting section 113, the port detecting section 114, the information managing section 115, and the packet transferring section 116. Furthermore, description of content of the address information 231 and content of the transfer information 232 is omitted because the content of the address information 231 and the content of the transfer information 232 are the same as the content of the address information 131 and content of the transfer information 132.

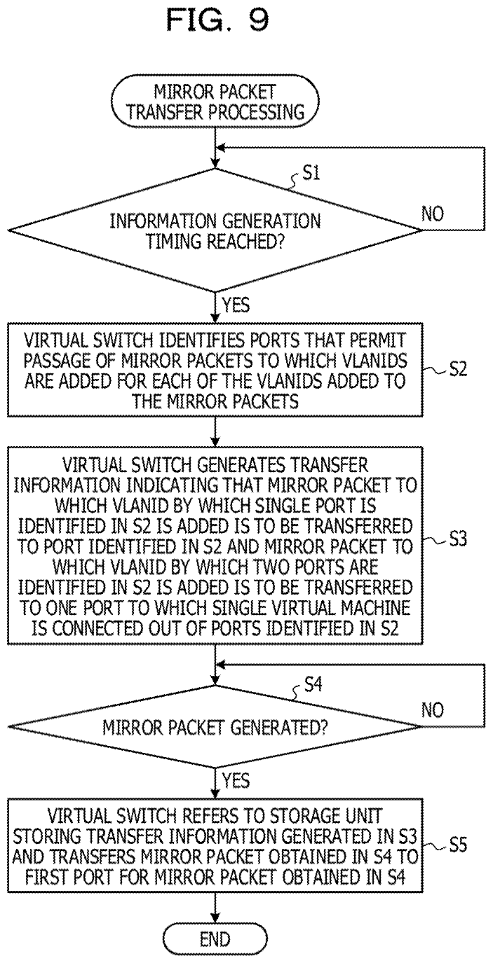

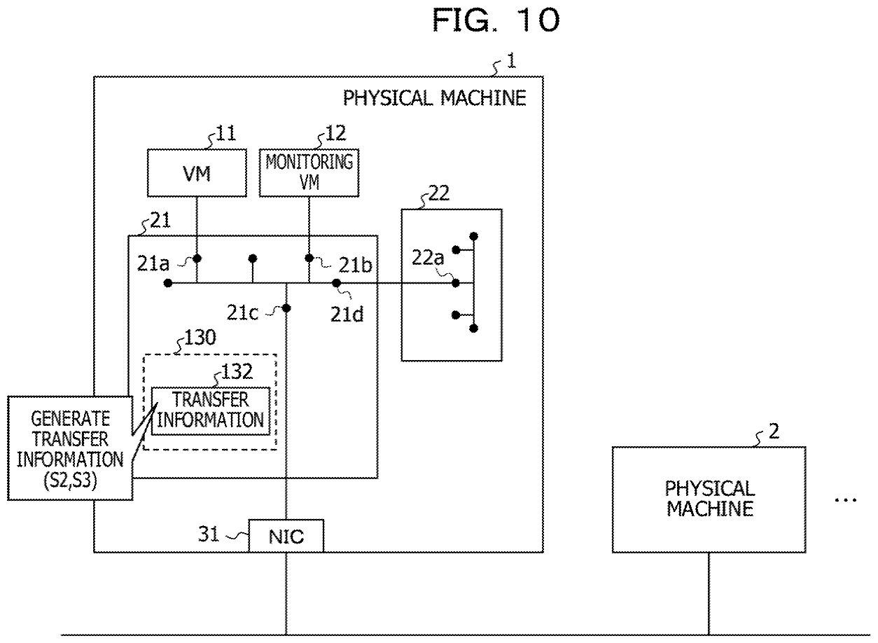

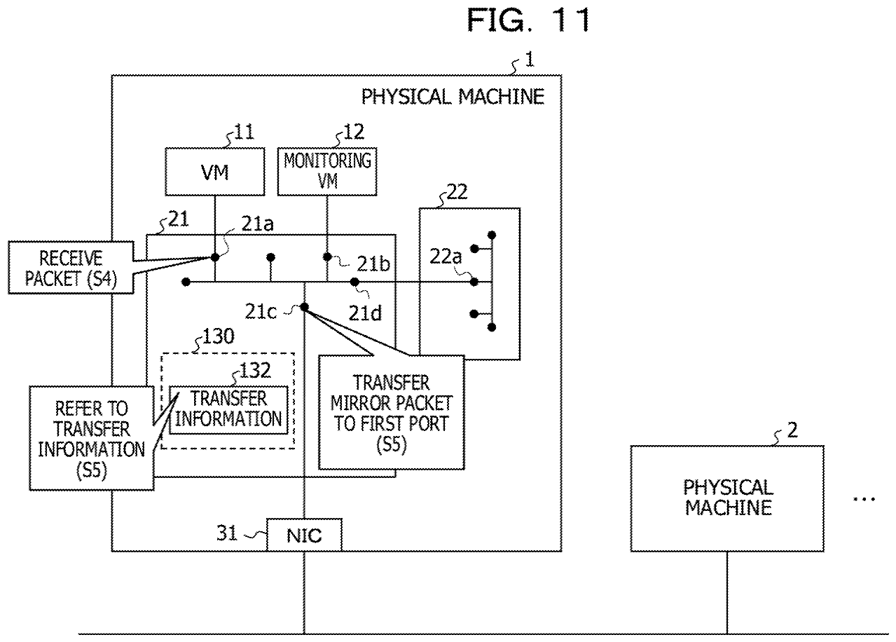

Next, an overview of a first embodiment will be described FIG. 9 is a flowchart illustrating an overview of the mirror packet transfer processing according to the first embodiment. FIGS. 10 and 11 are diagrams illustrating an overview of the mirror packet transfer processing according to the first embodiment. The packet transfer processing performed in the SW 21 is described below. The packet transfer processing performed in the SW 23 is the same as the packet transfer processing performed in the SW 21, thereby description thereof is omitted.

As illustrated in FIG. 9, the SW 21 waits until information generation timing is reached (“NO” in S1). At the information generation timing, the transfer information 132 is generated. The information generation timing may be, for example, timing at which a business entity inputs to the physical machine 1 information indicative of generation of the transfer information 132.

Then, when the information generation timing is reached (“YES” in S1), the SW 21 identifies ports that permit passage of mirror packets to which VLANIDs are added for each of the VLANIDs added to the mirror packets (S2).

Then, the SW 21 generates the transfer information 132 indicating that a mirror packet to which a VLANID by which a single port is identified in the processing in S2 is added is to be transferred to the port identified in the processing in S2 and a mirror packet to which a VLANID by which two ports are identified in the processing in 52 is added is to be transferred to one port to which a single VM is connected out of the ports identified in the processing in S2 (S3).

For example, as illustrated in FIG. 10, the SW 21 generates the transfer information 132 and stores the generated transfer information 132 to the information storage area 130 before transmission of the packets from the VM 11 is started.

After that, the SW 21 waits until a mirror packet is generated from the packet transmitted by the VM 11 (NO″ in 54).

When the mirror packet is generated from the packet transmitted from the VM 11 (“YES” in S4), the SW 21 refers to the information storage area 130 storing the transfer information 132 generated in the processing in 93, and the SW 21 transfers the mirror packet obtained in the processing in S4 to the first port for the mirror packet obtained in the processing in S4 (S5).

For example, when the port 21a of the SW 21 receives the packet transmitted from the VM 11 as illustrated in FIG. 11, the mirror packet is generated from the received packet. Then, the SW 21 refers to the information storage area 130 storing the transfer information 132, and, for example, identifies the port 21c corresponding to the generated mirror packet (the VLANID added to the mirror packet). After that, the SW 21 transfers the generated mirror packet to the port 21c.

Thus, even when a virtual switch performing the tunneling processing (the virtual switch that generates information by which a physical machine where the monitoring VM 12 is generated is identified) does not exist in the same physical machine, the SW 21 is able to transfer the mirror packet to the monitoring VM 12.

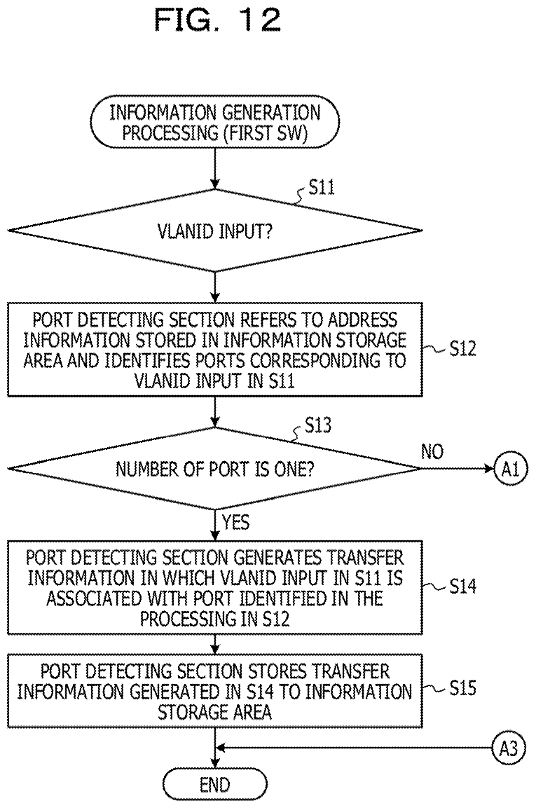

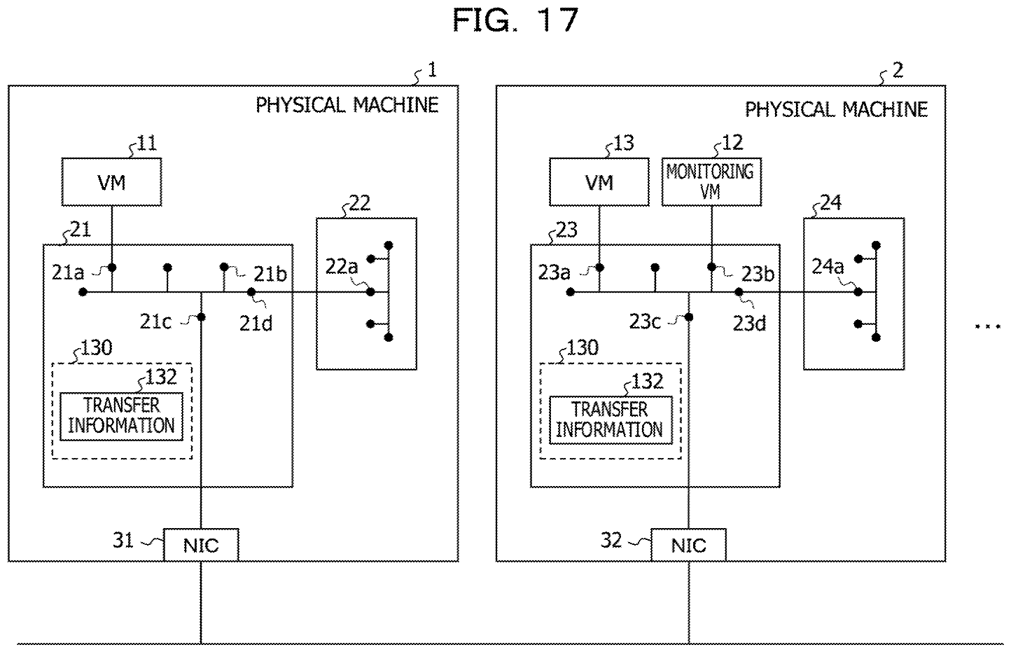

Next, the details of the first embodiment will be described. FIGS. 12 to 16 are flowcharts illustrating the details of the mirror packet transfer processing according to the first embodiment. FIGS. 17 to 21 are diagrams illustrating the details of the mirror packet transfer processing according to the first embodiment.

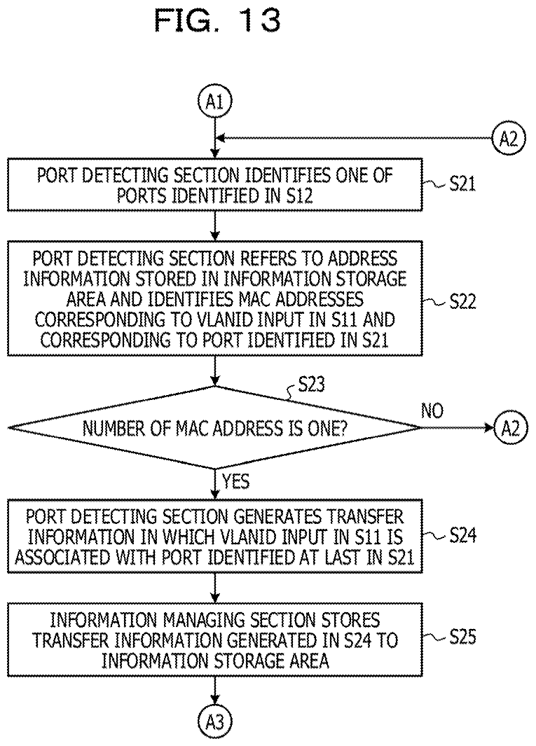

First, processing for generating the transfer information 132 (also referred to as “information generation processing” hereinafter) of the mirror packet transfer processing is described. FIGS. 12 and 13 are flowcharts illustrating information generation processing.

As illustrated in FIG. 12, the port detecting section 114 of the SW 21 waits until a VLANID is input (“NO” in S11). For example, the port detecting section 114 waits until the business entity inputs the VLANID (a VLANID for which the transfer information 132 is generated) to the physical machine 1.

Then, when the VLANID is input (“YES” in S11), the port detecting section 114 refers to the address information 131 stored in the information storage area 130 and identifies ports corresponding to the VLANID input in the processing in S11 (S12). Hereinafter, an example of the address information 131 is described.

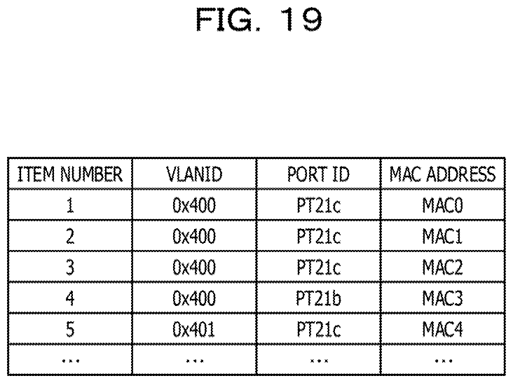

FIG. 19 is a diagram illustrating an example of the address information 131. The address information 131 illustrated in FIG. 19 includes as items, an item number (“ITEM NUMBER”), a VLANID (“VLANID”), a port ID (“PORT ID”), and a MAC address (“MAC ADDRESS”). Pieces of information included in the address information 131 are stored in the item number. The VLANIDs added to the mirror packets are stored in the VLANID. Identification information of the ports of the SW 21 are stored as the port ID. MAC addresses of VMs are set in the MAC address. Hereinafter, the port 21b and the port 21c described with reference to, for example, FIG. 1 are also referred to as “PT 21b” and “PT 21c”, respectively.

For example, in the address information 131 illustrated in FIG. 9, for a piece of information the item number of which is “1”, “0×400” is stored as the VLANID “PT 21c” is stored as the port ID, and “MAC0” is stored as the MAC address.

In the address information 131 illustrated in FIG. 19, for a piece of information the item number of which is “2”, “0×400” is stored as the VLANID, “PT 21c” is stored as the port ID, and “MAC1” is stored as the MAC address.

In the address information 131 illustrated in FIG. 19, for a piece of information the item number of which is “3”, “0×400” is stored as the VLANID, “PT 21c” is stored as the port ID, and “MAC2” is stored as the MAC address.

In the address information 131 illustrated in FIG. 19, for a piece of information the item number of which is “4”, “0×400” is stored as the VLANID, “PT 21b” is stored as the port ID, and “MAC3” is stored as the MAC address. Description of other pieces of information included in FIG. 19 are omitted.

In the address information 131 illustrated in FIG. 19, for the pieces of information the VLANIDs of which are set to “4×400” (the pieces of information the item numbers of which are “1” to “4”), “PT 21c”, “PT 21c”, “PT 21c”, and “PT 21b” are stored as the port IDs, respectively. Thus, in the processing in S12, the port detecting section 114 identifies the “PT 21c” and the “PT 21b” as the ports corresponding to the VLANID input in the processing in S11.

Referring back to FIG. 12, the port detecting section 114 determines whether the number of ports identified in the processing in S12 is one (S13).

As a result, when the number of ports identified in the processing in S12 is determined to be one (“YES” in S13), the port detecting section 114 generates the transfer information 132 in which the VLANID input in the processing in S11 is associated with the port identified in the processing in S12 (S14).

For example, when the number of ports to which the mirror packet may be transferred is one, the port detecting section 114 is able to determine that the monitoring VM 12 is generated in a physical machine different from a physical machine where the SW 21 is generated In this case, the port detecting section 114 is able to determine that a single port to which the mirror packet may be transferred is connected to the monitoring VM 12.

Accordingly, in the processing in S14, the port detecting section 114 generates the transfer information 132 in which the VLANID input in the processing in S11 is associated with the port identified in the processing in S12 (port to which the mirror packet may be transferred). An example of the transfer information 132 is described hereinafter.

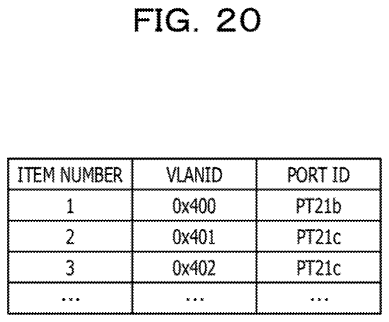

FIG. 20 is a diagram illustrating an example of the transfer information 132. For example, FIG. 20 illustrates an example of the transfer information 132 about the ports of the SW 21.

The transfer information 132 illustrated in FIG. 20 includes, as items, the item number (“ITEM NUMBER”), the VLANID (“VLANID”), and the port ID (“PORT ID”). Pieces of information included in the, transfer information 132 are stored in the item number. The VLANIDs added to the mirror packets are stored in the VLANID. Identification information of the ports of the SW 21 are stored in the port ID.

For example, in the transfer information 132 illustrated in FIG. 20, for the piece of information the item number of which is “1”, “0×400” is stored as the VLANID, and “PT 21b” is stored as the port ID. For example, the piece of information the item number of which is “1” indicates that, when a mirror packet to which “0×400”, as the VLANID, is added is generated, the generated mirror packet is to be transferred to the port the port ID of which is “PT 21b”.

In the transfer information 132 illustrated in FIG. 20, for the piece of information the item number of which is “2”, “0×401” is stored as the VLANID, and “PT 21c” is stored as the port ID. For example, the piece of information the item number of which is “2” indicates that, when a mirror packet to which “0×401”, as the VLANID, is added is generated, the generated mirror packet is to be transferred to the port the port ID of which is “PT 21c”.

In the transfer information 132 illustrated in FIG. 20, for the piece of information the item number of which is “3”, “0×402” is stored as the VLANID, and “PT 21c” is stored as the port ID. For example, the piece of information the item number of which is “3” indicates that, when a mirror packet to which “0×402”, as the VLANID, is added is generated, the generated mirror packet is to be transferred to the port the port ID of which is “PT 21c”,

Referring back to FIG. 12, the port detecting section 114 stores the transfer information 132 generated in the processing in S14 to the information storage area 130 (S15).

In contrast, when it is determined that the number of ports identified in the processing in S12 is other than one (the number of ports is two; “NO” in S13), as illustrated in FIG. 13, the port detecting section 114 identifies one of the ports identified in the processing in S12 (S21).

The port detecting section 114 refers to the address information 131 stored in the information storage area 130 and identifies MAC addresses corresponding to the VLANID input in the processing in S11 and corresponding to the, port identified in the processing in S21 (S22).

For example, in the address information 131 illustrated in FIG. 19, the MAC addresses of pieces of information in which the VLANIDs are “4×400” and the port IDs are “PT 21c” (pieces of information the item numbers, of which are “1” to “3”) are “MAC0”, “MAC1”, and “MAC2”,

Accordingly, when the VLANID input in the processing in S11 is “0×400” and the port ID identified in the processing in S21 is “PT 21c”, the port detecting section 114 identifies “MAC0”, “MAC1” and “MAC2” as the MAC addresses in the processing in S22.

In contrast, in the address information 131 illustrated in FIG. 19, the MAC address of a piece of information in which the VLANID is “0×400” and the port ID is “PT 21b” (piece of information the item number of which is “4”) is “MAC3”.

Accordingly, when the VLANID input in the processing in S11 is “0×400” and the port ID identified in the processing in S21 is “PT 21b”, the port detecting section 114 identifies “MAC3” as the MAC address in the processing in S22.

Then, when the number of the MAC addresses identified in the processing in S22 is other than one (“NO” in S23), the port detecting section 114 performs the processing in and after S21 again.

In contrast, when the number of MAC addresses identified in the processing in S22 is one (“YES” in S23), the port detecting section 114 generates the transfer information 132 in which the VLANID input in the processing in S11 is associated with the port identified at last in the processing in S21 (S24).

After that, the information managing section 115 of the SW 21 stores the transfer information 132 generated in the processing in S24 to the information storage area 130 (S25). Then, the SW 21 ends the information generation processing.

For example, when the number of ports to which the mirror packet may be transferred is two, the port detecting section 114 is able to determine that the monitoring VM 12 is generated in the same physical machine as a physical machine where the SW 21 is generated (physical machine 1). In this case, the port detecting section 114 is able to determine that, out of the two ports to which the, mirror packet may be transferred, one of the ports is connected to the monitoring VM 12 and the other port is connected the outside of the physical machine 1.

Also, it is able to be determined that the port corresponding to two or more MAC addresses is a port connected to the outside the physical machine 1. In contrast, it is able to be determined that the port corresponding to a single MAC address is a port connected to a single VM generated in the same physical machine as a physical machine where the SW 21 is generated (physical machine 1).

Accordingly, in the processing in S24, the port detecting section 114 generates the transfer information 132 in which the VLANID input in the processing in S11 is associated with the port identified at last in the processing in S21 (the port corresponding to a single MAC address) An example of the information generation processing is described hereinafter.

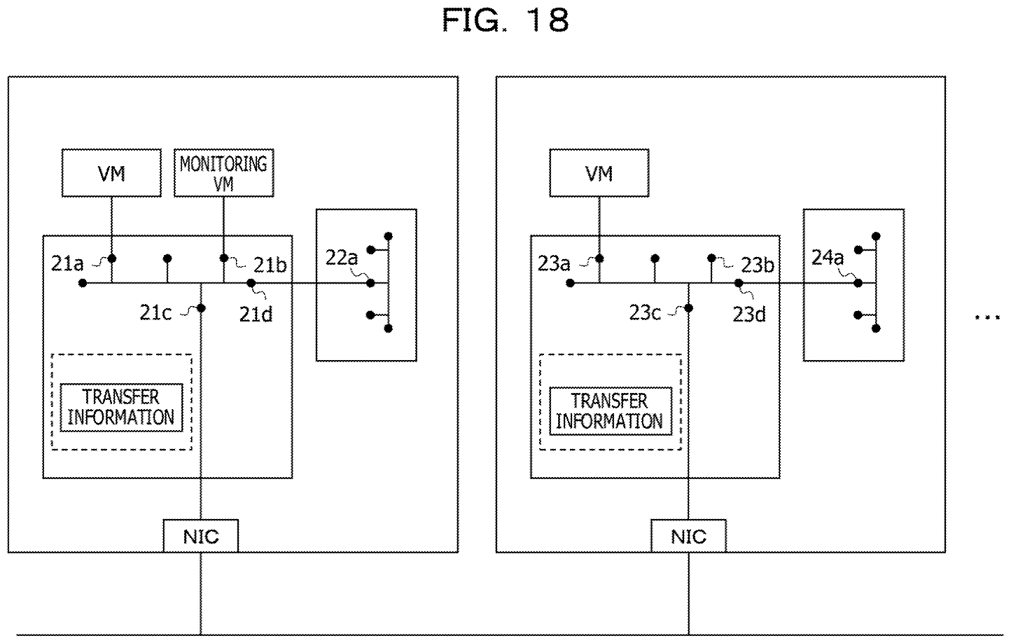

FIGS. 17 and 18 are diagrams illustrating an example of the information generation processing. First, an example when the monitoring VM 12 is generated in the physical machine 2 is described. FIG. 17 is a diagram illustrating the example when the monitoring VM 12 is generated in the physical machine 2. In the following example, it is assumed that 0×400, as the VLANID, is added to a mirror packet transmitted from the VM 11. In the following description, it is also assumed that, in the example illustrated in FIG. 17, each of the port 21c, the port 23b, and the port 23c is set to relay a mirror packet the VLANID of which is 0×400.

In the example illustrated in FIG. 17, out of the ports of the SW 21, only the port 21c relays the mirror packet (mirror packet of the packet transmitted from the VM 11) to which 0×400, as the VLANID, is added in the port 21a.

Thus, in this case, the port detecting section 114 generates the transfer information 132 indicating that the mirror packet to which 0×400 is added as the VLANID is to be transmitted to the port 21c.

Next, an example when the monitoring VM 12 is generated in the physical machine 1 is described. FIG. 18 is a diagram illustrating the example when the monitoring VM 12 is generated in the physical machine 1. In the following description, it is assumed that, in the example illustrated in FIG. 18, each of the port 21b, the port 21c, and the port 23c is set to relay a mirror packet the VLANID of which is 0×400 (setting of the VLAN).

In the example illustrated in FIG. 18, out of the ports of the SW 21, the port 21b or the port 21c relays the mirror packet (mirror packet of the packet transmitted from the VM 11) to which 0×400, as the VLANID, is added in the port 21a.

The address information 131 illustrated in FIG. 19 includes information indicating that the number of MAC addresses corresponding to the port 21c is three and the number of 1AC addresses corresponding to the port 21b is one.

Accordingly, out of the port 21b and the ports 21c that relay the mirror packet to which 0×400 is added as the VLANID, the port detecting section 114 is able to identify the port 21b corresponding to a single MAC address as the port connected to the monitoring VM 12. Thus, in this case, the port detecting section 114 generates the transfer information 132 indicating that the mirror packet to which 0×400 is added as the VLANID is to be transmitted to the port 21b.

Thus, even when a virtual switch performing the tunneling processing does not exist in the same physical machine (physical machine), the SW 21 is able to transfer the mirror packet to the monitoring VM 12.

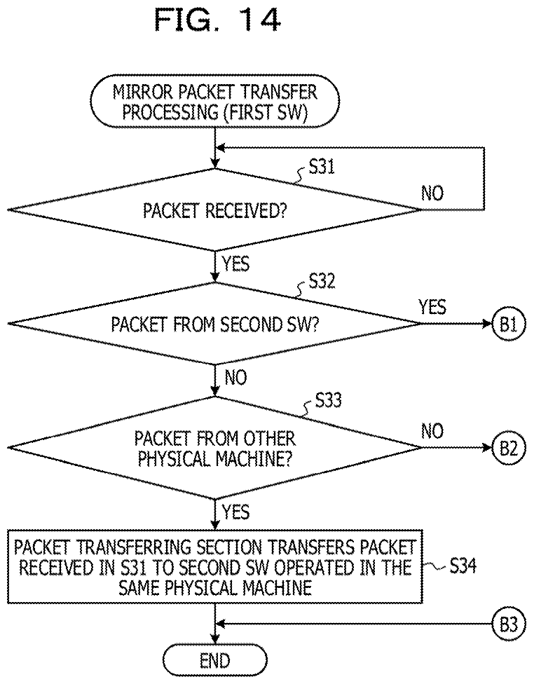

Next, processing of the mirror packet transfer processing other than the information generation processing is described. FIGS. 14 to 16 are flowcharts illustrating the processing of the mirror packet transfer processing other than the information generation processing.

As illustrated in FIG. 14, the packet receiving section 111 of the SW 21 waits until a packet transmitted from outside the SW 21 is received (“NO” in S31). For example, the packet receiving section 111 waits until the port 21a receives a packet transmitted from the VM 11, the port 21d receives a packet transmitted from the SW 22, or the port 21c receives a packet transmitted from the other physical machine such as a physical machine 2 (VM generated in the other physical machine).

Then, when a packet transmitted from outside the SW 21 is received (“YES” in S31), the packet receiving section 111 determines whether the received packet is transmitted from the SW 22 (S32).

When it is determined that the packed received in the processing in S31 is not transmitted from the SW 22 (“NO” in S32), the packet receiving section 111 determines whether the packet received in the processing in S31 is transmitted from the other physical machine such as a physical machine 2 (S33).

As a result, when it is determined that the packed received in the processing in S31 is transmitted from the other physical machine such as a physical machine 2 (“YES” in S33), the packet transferring section 116 of the SW 21 transfers the packet received in the processing in S31 to the SW 22 operated in the same physical machine 1 (S34). Then, the SW 21 ends the mirror packet transfer processing.

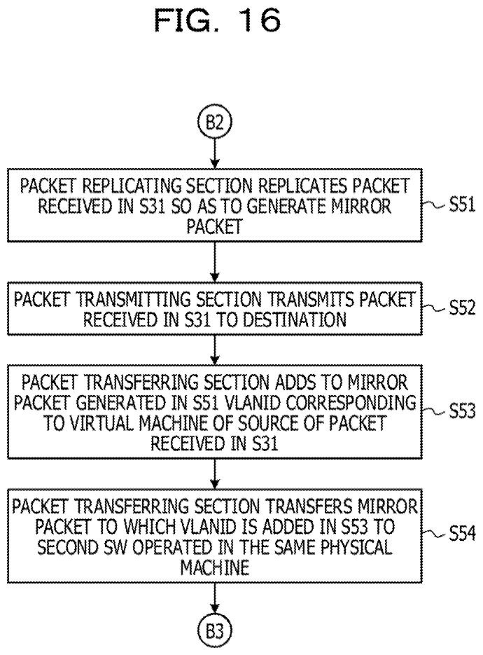

In contrast, when it is determined that the packet received in the processing in S31 is not transmitted from, the other physical machine, for example, it is determined that the packet received in the processing in S31 is transmitted from the VM 11 (“NO” in S33), the packet replicating section 112 of the SW 21 replicates the packet received in the processing in S31 so as to generate a mirror packet as illustrated in FIG. 16 (S51).

Next, the packet transmitting section 113 of the SW 21 transmits the packet received in the processing in S31 to the destination (S52).

Then, the packet transferring section 116 adds to the mirror packet generated in the processing in S51 a VLANID corresponding to the VM of the source of the packet received in the processing in S31 (S53).

For example, when the VM of the source of the packet received in the processing in S31 is the VM 11, the packet transferring section 116 adds to the mirror packet generated in the processing in S51 a VLANID corresponding to the VM 11. Hereinafter, an example of the mirror packet to which the VLANID is added is described.

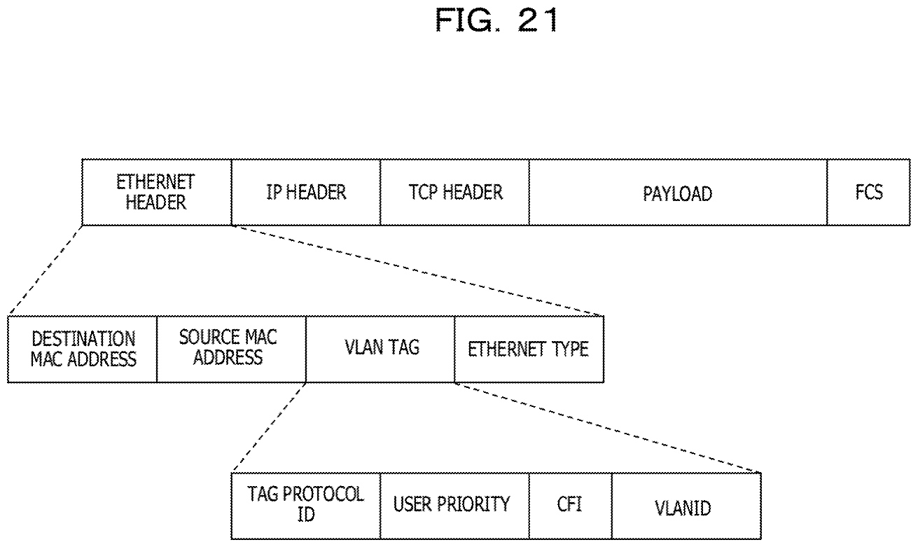

FIG. 21 is a diagram illustrating an example of the mirror packet to which the VLANID is added. As illustrated in FIG. 21, an area corresponding to VLANID is included in an area corresponding to a VLAN tag (“VLAN TAG”) included in an Ethernet (registered trademark) header (“Ethernet header”) of the mirror packet. Thus, in the processing in S53, the packet transferring section 116 sets, for example, in the region corresponding to VLANID the VLANID corresponding to the VM of the source of the packet received in the processing S31.

Referring back to FIG. 16, the packet transferring section 116 transfers the mirror packet to which the VLANID is added in the processing in S53 to the SW 22 operated in the same physical machine 1 (S54). Then, the SW 21 ends the mirror packet transfer processing.

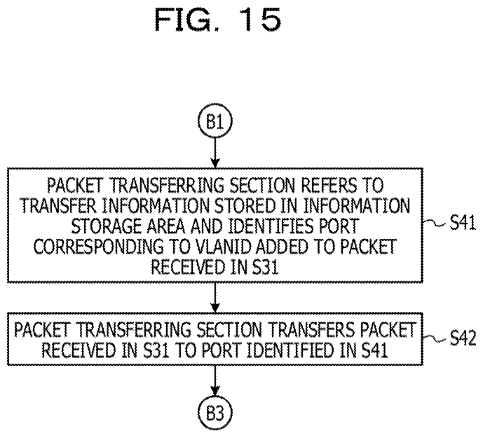

When, in the processing in S32, it is determined that the packet received in the processing in S31 is transmitted from the SW 22 (“YES” in S32), as illustrated in FIG. 15, the packet transferring section 116 refers to the transfer information 132 stored in the information storage area 130 and identifies a port corresponding to the VLANID added to the packet received in the processing in S31 (S41).

For example, in the transfer information 132 illustrated in FIG. 20, “PT 21b” is stored in the port ID corresponding to the piece of information the VLANID of which is “0×400” (the piece of information the item number of which is “1”). Thus, when the VLANID corresponding to the VM 11 is 0×400, the packet transferring section 116 identifies the PT 21b as the port ID in the processing in S41.

For example, in this case, the packet transferring section 116 identifies that the monitoring VM 12 is generated in the same physical machine (physical machine 1) as the physical machine where the SW 21 is generated and the monitoring VM 12 is connected to the port 21b.

Then, the packet transferring section 116 transfers the packet received in the processing in S31 to the port identified in the processing in S41 (S42).

Thus, the SW 21 is able to transfer a mirror packet to the monitoring VM 12 when referring to the transfer information 132 generated in advance. Thus, even when a virtual switch performing the tunneling processing is not generated in the physical machine 1, the SW 21 is able to transfer the mirror packet to the monitoring VM 12.

As described above, according to the present embodiment, on a VLANID-by-VLANID basis for the VLANIDs added to mirror packets, the SW 21 identifies the ports that permit passage of the mirror packets to which the VLANIDs are added. Then, the SW 21 generates the transfer information 132 indicating that a mirror packet to which a VLANID by which a single port is identified is added is to be transferred to the identified port and that a mirror packet to which a VLANID by which two ports are identified is added is to be transferred to one port to which a single virtual machine is connected out of the identified ports.

After that, when the first mirror packet is generated due to reception of the packet from the VM 11, the SW 21 refers to the information storage area 130 storing the transfer information 132 and transfers the first mirror packet to the first port corresponding to the first mirror packet.

For example, the SW 21 identifies the number of ports corresponding to VLANs on a VLAN-by-VLAN basis, and further, identifies the number of VMs connected to each of the ports ahead of the port. When a VLAN corresponding to a single port exists, the SW 21 determines that the monitoring VM 12 for this VLAN is generated in the physical machine 2 different from the physical machine where the SW 21 is generated. When a VLAN corresponding to two ports exists, the SW 21 determines, in accordance with the number of VMs connected to each of the ports ahead of the port, the physical machine where the monitoring VM 12 for this VLAN is generated.

Thus, even when a virtual switch performing the tunneling processing (the virtual switch that generates information for identifying a physical machine where the monitoring VM 12 is generated) does not exist in the physical machine 1 being the same physical machine, the SW 21 is able to transfer the mirror packet to the monitoring VM 12.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification, relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented method of transferring a mirror packet comprising:
obtaining a first mirror packet;
transferring, based on a first virtual local area network identifier added to the first mirror packet when only a first port permits passage of a mirror packet to which the first virtual local area network identifier is added, the first mirror packet to the first port; and
transferring, based on the first virtual local area network identifier added to the first mirror packet when a plurality of ports permit passage of a mirror packet to which the first virtual local area network identifier is added, the first mirror packet to a second port for which only a single destination address is registered, the second port being included in the plurality of ports.

2. The method of transferring a mirror packet according to claim 1, wherein
the single destination address is a media access control address of a virtual machine.

3. The method of transferring a mirror packet according to claim 1, wherein
the obtaining of the first mirror packet, the transferring of the first mirror packet to the first port, and the transferring of the first mirror packet to the second port are performed by a first virtual switch, and
the obtaining of the first mirror packet is performed in response to transferring the first mirror packet from a second virtual switch coupled to the first virtual switch via a third port.

4. The method of transferring a mirror packet according to claim 3, wherein
the first mirror packet is generated by replicating a packet transmitted from a virtual machine allocated in a physical machine where the first virtual switch is allocated.

5. The method of transferring a mirror packet according to claim 3, wherein
the first mirror packet is generated by replicating a packet transmitted from a virtual machine allocated in a first physical machine different from a second physical machine where the first virtual switch is allocated.

6. A system for transferring a or packet comprising:
one or more memories; and
one or more processors coupled to the one or more memories and the one or more processor configured to:
perform obtainment of a first mirror packet,
perform, based on a first virtual local area net work identifier added to the first mirror packet when only a first port permits passage of a mirror packet to which the first virtual local area network identifier is added, transfer of the first mirror packet to the first port; and
perform, based on the first virtual local area network identifier added to the first mirror packet when a plurality of ports permit passage of a mirror packet to which the first virtual local area network identifier is added, the first mirror packet to a second port for which only a single destination address is registered, transfer of the second port being included in the plurality of ports.

7. The system for transferring mirror packet according to claim 6, wherein p1 the single destination address is a media access control address of a virtual machine

8. The system for transferring a mirror packet according to claim 6, wherein
the obtainment of the first mirror packet, the transfer of the first mirror packet to the first port, and the transfer of the first mirror packet to the second port are performed by a first virtual switch, and
the obtainment of the first mirror packet is performed in response to transferring the first mirror packet from a second virtual switch coupled to the first virtual switch via a third port.

9. The system for transferring a mirror packet according to claim 8, wherein'
the first mirror packet is generated by replicating a packet transmitted from a virtual machine allocated in a physical machine where the first virtual switch is allocated.

10. The system for transferring a mirror packet according to claim 8, wherein
the first mirror packet is generated by replicating a packet transmitted from a virtual machine allocated in a first physical machine different from a second physical machine where the first virtual switch is allocated.

11. A non-transitory computer-readable medium storing instructions executable by one or more computers, the instructions comprising:
one or more instructions for obtaining a first mirror packet;
one or more instructions for transferring, based on a first virtual local area network identifier added to the first mirror packet when only a first port permits passage of a mirror packet to which the first virtual local area network identifier is added, the first mirror packet to the first port; and
one or more instructions for transferring, based on the first virtual local area network identifier added to the first mirror packet when a plurality of ports permit passage of a mirror packet to which the first virtual local area network identifier is added, the first mirror packet to a second port for which only a single destination address is registered, the second port being included in the plurality of ports.
